(19) United States
(12) Patent Application Publication
(10) Pub. No.: US 2005/0109980 A1
(43) Pub. Date: May 26, 2005

(54) Polishing composition for CMP having abrasive particles

(76) Inventor: Hongyu Wang, Wilmington, DE (US)

Correspondence Address: Rodel Holdings, Inc., Suite 1300, 1105 North Market Street, Wilmington, DE, 19899, US

(21) Appl. No.: 10/723,746

(22) Filed: Nov. 25, 2003

(51) Int. Cl. C09K 13/00

(52) U.S. Cl. 252/79.1

(57) ABSTRACT

An aqueous polishing slurry is suitable for chemical mechanical polishing semiconductor substrates. The slurry comprises, by weight percent, 0.1 to 40 weight percent metal oxide particles, the metal oxide particles having a surface and a positive surface charge; at least 0.001 polynaphthalene surfactant for adsorption with at least a portion of the surface of the metal oxide particles in situ and for reducing scratching of the semiconductor substrates; and a balance of water with the slurry having a pH of less than 10.

### BACKGROUND OF THE INVENTION

This invention relates to polishing slurries useful for polishing semiconductor substrates.

Chemical mechanical planarization (CMP) refers to a process of polishing a workpiece with a moving polishing pad and a fluid polishing composition. A layer of material at the surface of the workpiece is removed by chemically interacting with the polishing composition to facilitate removal of wafer components at a predictable rate. To apply further abrasion, the fluid polishing composition is provided with dispersed abrasive particles in fluid suspension. During CMP, the wafer's top layer of material is polished to form a planar polished surface. This polished layer of material is referred to as a planarized layer. Polishing of the planarized layer often continues until the planarized layer is completely removed from an underlying material. Furthermore, the polished layer provides a planarized surface on which successive layers of materials are constructed to form elements of semiconductor circuit devices.

K. Hasegawa discloses a polishing method and solution in U.S. patent Pub. No. 2002/0098701. This solution optionally contains a cationic, anionic or nonionic surfactant for restraining erosion. The anionic surfactants include: fatty acid soaps; carboxylic acid salts; such as, salts of alkyl ether carboxylic acids; sulfonic acid salts, such as, alkylbenzenesulfonates, alkylnaphthalenesulfonates, alpha-olefin ether sulfonates; sulfuric acid ester salts, such as, higher alcohol sulfate ester salts, alkyl ether sulfates, polyoxyethylene alkylphenyl ether sulfates; and phosphoric acid ester salts, such as, alkylphosphoric acid ester salts.

When CMP is performed to remove a layer of a noble metal, such as, platinum, relatively low chemical reactivity of the noble metal with the polishing composition contributes to relatively slow removal rate of the noble metal. To increase the removal rate of the noble metal layers, such as platinum, the polishing composition often relies upon large quantities of abrasive particles in fluid suspension that apply sufficient abrasion to accelerate the noble metal removal. These abrasive particles, however, tend to scratch the surface being polished by the abrasive particles, especially when the abrasive particles agglomerate to form larger particles that further tend to increase scratching. Scratches comprise undesired increases in step height in the planarized surface or defects in the planar polished surface. There is an ongoing demand for polishing solutions that maintain adequate removal rate with reduced scratching. In particular, there is a demand for abrasive particles that abrade metals, such as copper, noble metals, tungsten and their alloys at an acceptable rate with reduced scratching of the metal.

### SUMMARY OF THE INVENTION

The invention provides an aqueous polishing slurry suitable for chemical mechanical polishing semiconductor substrates, comprising, by weight percent: 0.1 to 40 weight percent metal oxide particles, the metal oxide particles having a surface and a positive surface charge; at least 0.001 polynaphthalene surfactant for adsorption with at least a portion of the surface of the metal oxide particles in situ and for reducing scratching of the semiconductor substrates; and a balance of water with the slurry having a pH of less than 10.

In another aspect, the invention provides a method of chemical mechanical polishing a semiconductor substrate comprising polishing with an aqueous polishing slurry comprising, by weight percent, 0.1 to 40 weight percent metal oxide particles, the metal oxide particles having a surface and a positive surface charge; at least 0.001 polynaphthalene surfactant for adsorption with at least a portion of the surface of the metal oxide particles in situ and for reducing scratching of the semiconductor substrates; and a balance of water with the slurry having a pH of less than 10.

### DETAILED DESCRIPTION

A polynaphthalene surfactant coats at least a portion of the surface of metal oxide particles in an aqueous composition. The metal oxide particles have a positive surface charge that facilitates adsorption of the surfactant. For purposes of this specification, adsorption represents the surfactant's physisorption or otherwise covering the particle's surface. Although the slurries are effective with the polynaphthalene surfactant covering only a portion of the surface of the metal oxide particles' surface, typical slurries are most effective with the surfactant covering enveloping the entire particles' surface. For example, slurries containing sufficient surfactant to cover at least 10 percent of the particles' surface can reduce scratching while achieving acceptable polishing rates. Preferably, the surfactant covers at least 50 percent of the particles' surface. Most preferably, the surfactant has an over-saturated concentration of surfactant wherein a detectable fraction of the surfactant remains in solution. This over-saturated concentration of surfactant may cover less than the entire particles' surface.

The polynaphthalene surfactant can have an anionic or nonionic structure that bonds to the metal oxide surface. Preferably, the polynaphthalene surfactant is an anionic surfactant. Most preferably, the polynaphthalene surfactant is a sulfonated anionic surfactant.

These surfactants adsorb to positively charged metal oxide particles to modify the particles' polishing characteristics. In particular, these surfactants facilitate reduced scratching of semiconductor substrates. For purposes of this specification, reduced scratching represents a measurable decrease in scratching of a wafer obtained by introducing the surfactant into the slurry. For example, polishing platinum wafers under the conditions of the Example reduces scratching of the metal by a detectable amount.

An addition of at least 0.001 weight percent polynaphthalene surfactant will reduce scratching. Preferably, the slurry includes at least 0.01 weight percent weight percent polynaphthalene surfactant. Most preferably, the slurry contains 0.5 to 5 weight percent polynaphthalene surfactant.

Increasing the concentration of the abrasive particles increases the abrasion applied by the abrasive particles, and increases the removal rate of a desired wafer layer, such as a noble metal during CMP. For purposes of this specification, noble metal refers to gold, silver, platinum, palladium, iridium, rhodium, ruthenium, osmium and their alloys. Too high a concentration of abrasive particles produces heavily applied abrasion, causing defects in planarization and defects in the polished surface. Conversely, decreasing the concentration of the abrasive particles will decrease the rate of removal of the wafer layer during CMP. Too low a concentration of abrasive particles will slow the rate of removal of the noble metal and will increase the time required for CMP beyond economically acceptable limits.

To ensure uniform coating of the abrasive particles, the surfactant is dissolved in the polishing composition at a concentration that varies directly with a corresponding variation in the concentration of the abrasive particles to be coated. In addition, the polynaphthalene surfactant acts as a dispersing agent, or dispersant, of the metal oxide particles. The surfactant reduces agglomeration of the particles to maintain a dispersion of the particles throughout the fluid polishing composition. Reducing the agglomeration of metal oxide particles can further reduce scratching by reducing the amount of large particles that can scratch metal surfaces.

The slurry operates in an aqueous system with a balance water. Preferably, the water is deionized water or another source of high-purity water to limit impurities. In addition, pH levels of less than 10 facilitate maintaining the particles' positive charge. Preferably, the slurry has a pH of less than 5. Most preferably, the slurry has a pH of less than 4. Typical agents for adjusting pH downward include nitric acid, sulfuric acid, hydrochloric acid, phosphoric acid and organic acids. Most preferably, potassium hydroxide and hydrochloric acid provide final pH adjustments, as required.

Preferably, the metal oxide particles are selected from the group comprising alumina, aluminum hydroxide oxide, ceria, iron oxide, lanthanum oxide, magnesium oxide, nickel oxide, silica, titania, yttria and zirconia. If the metal oxide particles are silica, then the pH is preferably less than 2 to maintain the particles' positive charge. Most preferably, the metal oxide particles are alumina.

The composition optionally contains 0 to 25 weight percent oxidizer. The oxidizer is particularly effective in allowing operation of the slurry at acidic pH levels. Preferably, the solution contains 0.01 to 15 weight percent oxidizer. Most preferably, the solution contains 0.01 to 5 weight percent oxidizer. The oxidizing agent can be at least one of a number of oxidizing compounds, such as hydrogen peroxide, monopersulfates, iodates, magnesium perphthalate, peracetic acid, persulfates, bromates, perbromates, perchlorates, periodates, ferric nitrate, iron salts, cerium salts, Mn (III) salts, Mn(IV) salts and Mn (VI) salts, silver salts, copper salts, chromium salts, cobalt salts, halogens, hypochlorites and mixtures thereof. Furthermore, it is often advantageous to use a mixture of oxidizer compounds. Preferably, the oxidizer is either hydrogen peroxide or iodate. When the polishing slurry contains an unstable oxidizing agent, such as, hydrogen peroxide, it is often most advantageous to mix the oxidizer into the slurry at the point of use.

Suitable metals used for the interconnect include, for example, copper, copper alloys, gold, gold alloys, nickel, nickel alloys, platinum group metals, platinum group metal alloys, silver, silver alloys, tungsten, tungsten alloys and mixtures comprising at least one of the foregoing metals. In copper polishing compositions and slurries that utilize oxidizers, such as, hydrogen peroxide, both the copper removal rate and the static etch rate are high primarily because of oxidation of the copper. In order to reduce the removal rate of the interconnect metal the polishing composition optionally employs a corrosion inhibitor. The corrosion inhibitors function to reduce removal of the interconnect metal. This facilitates improved polishing performance by reducing the dishing of the interconnect metal.

The inhibitor is optionally present in an amount of 0 to 6 wt %—the inhibitor may represent a single or a mixture of inhibitors to the interconnect metal. Within this range, it is desirable to have an amount of inhibitor greater than or equal to 0.0025 wt %, preferably greater than or equal to 0.25 wt %. Also desirable within this range is an amount of less than or equal to 4 wt %, preferably less than or equal to 1 wt %. The preferred corrosion inhibitor is benzotriazole (BTA). In one embodiment, the polishing composition may contain a relatively large quantity of BTA inhibitor for reducing the interconnect removal rate. At BTA concentrations above 0.25 wt %, an addition of supplemental corrosion inhibitors may be unnecessary. The preferred concentration of BTA is an amount of 0.0025 to 2 wt %.

Exemplary complexing agents for optional use in the polishing fluid include acetic acid, citric acid, ethyl acetoacetate, glycolic acid, lactic acid, malic acid, oxalic acid, salicylic acid, sodium diethyl dithiocarbamrate, succinic acid, tartaric acid, thioglycolic acid, glycine, alanine, aspartic acid, ethylene diamine, trimethylene diamine, malonic acid, gluteric acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, gallic acid, tannic acid and salts thereof. Preferably, the complexing agent used in the polishing fluid is citric acid. Most preferably, the polishing fluid contains 0 to 15 weight percent complexing agent.

The abrasive preferably has an average particle size of less than or equal to 1,000 nanometers (nm) for preventing excessive metal dishing and dielectric erosion. For purposes of this specification, particle size refers to the average particle size of the abrasive. It is desirable to use a colloidal abrasive having an average particle size of less than or equal to 500 nm, preferably less than or equal to 300 nm. The least dielectric erosion and metal dishing preferably occur with colloidal alumina having an average particle size of less than or equal to 200 nm. The chemical mechanical planarizing composition can also optionally include brighteners, such as, ammonium chloride, complexing agents, chelating agents, pH buffers, biocides and defoaming agents.

### EXAMPLES

Platinum-containing wafers were polished utilizing polishing compositions I and II with a without the polynaphthalene surfactant for comparative purposes.

Polishing composition I comprised: 1 wt % alpha-alumina abrasive particles; 0.2 wt % citric acid; 0.2 wt % sodium thiosulfate; 1 wt % aluminum nitrate; and balance deionized water. The pH of composition I was adjusted to 2.0 utilizing hydrochloric acid. Without a surfactant in the polishing composition, the abrasive particles of 130 nm average particle size, agglomerated to form agglomerates of 900 nm average particle size. Sodium thiosulphate is a substance providing sulfur-containing ions as ligands that adsorbed to platinum wafer, for platinum dissolution in the polishing compositions I or II, which contributes to removal of the platinum during CMP without the use of an oxidizing agent, or an oxidizer, of the platinum. Aluminum nitrate adds aluminum ions that correspond to the solubility limit of aluminum ions at a pH level of 2, which provides an environment of equilibrium dissolution for the alumina particles, at a stabilized pH level of 2. Citric acid can decrease dissolution of silicon dioxide into the polishing composition at a pH level of 2 as adjusted by hydrochloric acid. For example, when a noble metal, such as platinum is removed from an underlying insulating layer of silicon dioxide by CMP, a decrease in the dissolution of silicon dioxide during CMP is often desired.

For correspondence with a particle concentration of 1 wt % alpha alumina, a corresponding concentration of 0.1 wt % sulfonated polynaphthalene, LOMAR™, manufactured by Henkel Chemical Company, was dissolved in the polishing compositions I and II. The addition of sulfonated polynaphthalene dissolved in the polishing composition, adsorbed to the abrasive particles, remained dispersed in the polishing composition, and reduced formation of agglomerates.

Polishing composition II comprised: 1 wt % alpha-alumina; 0.2 wt % citric acid; 0.3 wt % sodium thiosulfate; 1 wt % aluminum nitrate; and balance deionized water. The pH of composition II was adjusted to 2.0 utilizing hydrochloric acid. Without a surfactant in the polishing composition, the abrasive particles of 130 nm, average particle size, agglomerated to form agglomerates having a 1,700 nm average particle size.

The sulfonated polynaphthalene addition dissolved in the polishing composition II, formed surfactant-coated abrasive particles that remained dispersed in the polishing composition II, and reduced formation of agglomerates.

The comparative testing relied upon 200 mm platinum blanket and patterned (Pt/TEOS) wafers polished on a Strasbaugh 6DS-SP rotary polisher. The polisher was equipped with a Rode1 IC1000 pad (XY groove, SUBA IV subpad) for use with the test slurries. AFM measurements were used for Rₐ and R_{MS} (Pt). The polishing baseline includes 20 sweeps pre-conditioning at 7.0 lbs (3.2 kg), and 2 sweeps ex-situ post conditioning at 7.0 lbs (3.2 kg), with a JL1 conditioning grid. Down force was 4 psi (27.6 kPa) with no backpressure. Platen speed was 80 rpm, and carrier speed was 60 rpm. Slurry flow rate was kept at 200 ml/min. Atomic force microscopy (AFM) scans were taken to provide the surface characteristics recorded in Table 1, of platinum wafers polished with II and I (with and without LOMAR™ surfactant). A Digital Instruments Dimension 5000 Atomic Force Microscope was utilized for all wafer surface characterizations employing a 20 micron by 20 micron scan area.

The following Table compares surface roughness of polishing compositions containing sulfonated polynaphthalene surfactants to comparative example without the surfactant.

TABLE

| | I without | I with | II without | II with |
|---|---|---|---|---|
| | sulfonated | sulfonated | sulfonated | sulfonated |
| | poly- | poly- | poly- | poly- |
| Surface | naphthalene | naphthalene | naphthalene | naphthalene |
| Roughness | surfactant | surfactant | surfactant | surfactant |
| Ra (nm) | 0.191 | 0.074 | 0.286 | 0.071 |
| R_{MS} (nm) | 0.266 | 0.106 | 0.381 | 0.101 |

Table 1 indicates that wafers polished by CMP with polishing compositions containing sulfonated polynaphthalene surfactant had substantially lower average roughness (Ra) and root mean square roughness (R_{MS}) compared to wafers polished with polishing compositions without sulfonated polynaphthalene surfactant. The scratches in wafers polished with polishing compositions without the surfactant had an average scratch width of 0.313 nm and an average scratch depth of 0.792 nm. With the utilization of the sulfonated naphthalene surfactant in the formulations, no detectable scratches were observed. In addition, the surfactant improved surface roughness and scratching with only a small decrease in platinum removal rate.

Although the Example demonstrates the products utility for a noble metal-containing wafer, this system has beneficial applications for multiple polishing applications, such as, patterned wafers, barrier removal, hardmask, low k patterned wafers, ultra-low k wafers, tungsten, interlayer dielectric and shallow trench isolation applications.

1. An aqueous polishing slurry suitable for chemical mechanical polishing semiconductor substrates, comprising, by weight percent:
0.1 to 40 weight percent metal oxide particles, the metal oxide particles having a surface and a positive surface charge;
at least 0.001 polynaphthalene surfactant for adsorption with at least a portion of the surface of the metal oxide particles in situ and for reducing scratching of the semiconductor substrates; and
a balance of water with the slurry having a pH of less than 10.

2. The aqueous polishing slurry of claim 1 wherein the metal oxide particles comprise an abrasive oxide selected from the group comprising alumina, aluminum hydroxide oxide, ceria, iron oxide, lanthanum oxide, magnesium oxide, nickel oxide, silica, titania, yttria and zirconia.

3. The aqueous polishing slurry of claim 1 wherein the metal oxide particles are alumina.

4. An aqueous polishing slurry suitable for chemical mechanical polishing semiconductor substrates, comprising, by weight percent:
0.25 to 25 weight percent metal oxide particles, the metal oxide particles having a surface and a positive surface charge and the metal oxide particles comprising an abrasive oxide selected from the group comprising alumina, aluminum hydroxide oxide, ceria, iron oxide, lanthanum oxide, magnesium oxide, nickel oxide, silica, titania, yttria and zirconia;
at least 0.01 polynaphthalene surfactant for adsorption with at least a portion of the surface of the metal oxide particles in situ and for reducing scratching of the semiconductor substrates; and
a balance of water with the slurry having a pH of less than 5.

5. The aqueous polishing slurry of claim 4 wherein the metal oxide particles are alumina.

6. An aqueous polishing slurry suitable for chemical mechanical polishing semiconductor substrates, comprising, by weight percent:
0.5 to 15 weight percent metal oxide particles, the metal oxide particles having a surface and a positive surface charge and the metal oxide particles comprising an abrasive oxide selected from the group comprising alumina, aluminum hydroxide oxide, ceria, iron oxide, lanthanum oxide, magnesium oxide, nickel oxide, silica, titania, yttria and zirconia;
at least 0.05 to 5 sulfonated polynaphthalene surfactant for adsorption with at least a portion of the surface of the metal oxide particles in situ and for reducing scratching of the semiconductor substrates; and
a balance of water with the slurry having a pH of less than 4.

7. The aqueous polishing slurry of claim 6 wherein the metal oxide particles are alumina.

8. A method of chemical mechanical polishing a semiconductor substrate comprising polishing with an aqueous polishing slurry comprising, by weight percent, 0.1 to 40 weight percent metal oxide particles, the metal oxide particles having a surface and a positive surface charge; at least 0.001 polynaphthalene surfactant for adsorption with at least a portion of the surface of the metal oxide particles in situ and for reducing scratching of the semiconductor substrates; and a balance of water with the slurry having a pH of less than 10.

9. The method of claim 8 wherein the chemical mechanical polishing removes a noble metal.

10. The method of claim 9 wherein the polishing includes the polishing slurry comprising 0.5 to 15 weight percent metal oxide particles, the metal oxide particles having a surface and a positive surface charge and the metal oxide particles comprising alumina; at least 0.05 to 5 polynaphthalene surfactant for adsorption with at least a portion of the surface of the metal oxide particles in situ and for reducing scratching of the semiconductor substrates; and a balance of water with the slurry having a pH of less than 4.
